(19) United States
(12) Patent Application Publication
(10) Pub. No.: US 2026/0152017 A1
(43) Pub. Date: Jun. 4, 2026

(54) THERMAL TRANSFER METHOD USING REACTIVE INK TRANSFER PAPER

(71) Applicant: Young-Sik CHON, Ansan-si (KR)

(72) Inventor: Young-Sik CHON, Ansan-si (KR)

(21) Appl. No.: 19/123,912

(22) PCT Filed: Oct. 17, 2023
(86) PCT No.: PCT/KR2023/015983

§ 371 Date: Apr. 24, 2025

(30) Foreign Application Priority Data
Oct. 27, 2022 (KR) 10-2022-0140412
Oct. 16, 2023 (KR) 10-2023-0137504

(51) Int. Cl. B41M 5/025; B41M 5/00; B41M 5/03; C09D 11/54; D06P 5/30

(52) U.S. Cl. CPC B41M 5/0256; B41M 5/0017; B41M 5/03; C09D 11/54; D06P 5/30

(57) ABSTRACT

The present invention relates to a fiber thermal transfer method using reactive ink transfer paper, and relates to digital printing, by means of a digital transfer printing device such as an inkjet printer, utilizing a computer from the design planning stage. The present invention, being a dry digital textile printing method with no steam and thickener used, is a waterless textile printing method which is ecofriendly.

### TECHNICAL FIELD

The present invention relates to a fiber thermal transfer method using reactive ink transfer paper.

### BACKGROUND ART

Conventional reactive dye textile printing has chronic environmental pollution (water and air pollution) and energy overconsumption problems. In addition, unfixed reactive dyes and a large amount of wastewater generated by washing the dyes are causes of water pollution of the present time, which cause extremely great environmental damage.

Due to an influence on labor environment, generation of foul odors due to the wastewater causes the textile industry to be considered as an undesirable industry, thereby threatening the textile industry itself.

Development of labor- and environment-friendly digital textile printing processes is required.

In summary, there are roughly two textile printing methods using reactive dyes.

1. A conventional reactive dye dyeing method in which a reactive dye is mixed with a thickener or a water-soluble polymer so as to dye an adherend (fibers and natural fibers such as cotton, silk, and flax), and steaming and washing are performed.

2. A process by a direct digital printing (DDP; direct textile printing) scheme, in which a garment and textile fabric are pretreated, a reactive dye is directly sprayed by an inkjet scheme to perform textile printing, and steaming and washing are performed, and a process by a batch scheme (a garment, etc.), in which a pretreatment is performed, printing is performed by an inkjet scheme, and curing is performed by heating.

The method in No. 1 causes water pollution and an increase in a cost price due to an increased energy cost caused by excessive water use. In particular, the water pollution is the biggest factor in environmental pollution, and damage caused by the water pollution is extremely great so that the water pollution has been pointed out as occupying the largest proportion of environmental pollution worldwide.

The method in No. 2 is a method discussed as being capable of significantly improving the conventional dyeing method (the method in No. 1), which is a digital method using a computer from a design stage. However, similar to the conventional dyeing method, steaming is required for dye-fixing (crosslinking) of a reactive printing layer, and washing is required to remove a reactive dye that has not been dye-fixed and a thickener that has been used, so that water pollution may be caused. In particular, halogen compounds generated from the reactive dyes may be lethal to the environment.

The direct textile printing (DDP scheme) is still technologically immature so as to have no great change from the conventional method except for an advantage of design freedom, and has a factor of an increase in a cost price due to excessive initial investment.

Although sublimation transfer of a polyester fiber has long been used as an example of a method for printing on a garment and textile fabric by using transfer paper, the method has a disadvantage of being only applicable to the polyester fiber.

As a printing method using a pigment on a fiber, there are screen printing and direct printing using the DDP scheme. The screen printing and the direct digital printing (DDP) scheme have an unavoidable disadvantage in an emotional aspect, which is the most important in fibers and garments, in addition to disadvantages of environmental pollution and high manufacturing costs.

In other words, regarding the screen printing method, the screen printing method has a poor touch sensation (soft feeling), it is difficult to perform printing with four colors or more, and four-color printing has difficulties due to cost price problems and technical problems except for simple designs using a single color, which are existing mostly.

The direct textile printing scheme (DDP) that supplements the disadvantages of the conventional reactive dye printing is being industrially used as a novel scheme.

The DDP scheme is the same as a reactive dye transfer paper scheme in terms of design freedom. However, since fabric formed by directly spraying and printing a reactive ink on the textile fabric requires the same steaming and washing processes as the conventional reactive dye dyeing scheme, the DDP scheme has a disadvantage of unavoidable environmental pollution, that is, water pollution, and work with reactive dyes is not industrially performed in the field of garments (shirts, etc.).

Therefore, a reactive dye printing method using transfer paper is being developed.

Korean Unexamined Patent Publication No. 10-2020-0006460, which is the related art, discloses a process of adding a process of steaming a rear surface of a target and a process of heat-curing a printed fiber to a general process of transfer paper. Therefore, the steaming and the heat curing have been used as a dye-fixing scheme in this patent of the related art.

### DISCLOSURE

### Technical Problem

Since the steaming and heat curing processes for fixing a dye according to the related art alone are insufficient for a reaction between the dye and an adherend (a garment), to overcome the problems described above, an object of the present invention is to provide a thermal transfer method using a reactive ink, to which a pretreatment process is added.

In addition, an object of the present invention is to provide a thermal transfer method capable of improving washing fastness of fabric in a pretreatment. In other words, an object of the present invention is to provide a thermal transfer method capable of performing printing without using water, and improving durability of a reactive dye, that is, washing fastness.

In addition, an object of the present invention is to provide transfer paper that is easily released and separated upon reactive dye thermal transfer using reactive ink transfer paper so as to improve printing quality.

### Technical Solution

To achieve the objects described above, there is provided a thermal transfer method using reactive dye transfer paper, the thermal transfer method including: preparing transfer paper in which a barrier layer and an ink reception layer are sequentially formed on base paper, and preparing the transfer paper having the ink reception layer on which an image is printed by a printing scheme; pretreating an adherend by dipping or coating the adherend with a substance capable of imparting hydroxyl; and printing the image by applying heat and pressure while the transfer paper on which the image is printed makes contact with the adherend.

Preferably, the pretreating of the adherend may include dipping or coating the adherend with a hydroxyl group impartment composition, or activating a surface of the adherend by performing a plasma treatment on the adherend.

The substance capable of imparting hydroxyl may contain a hydrophilic polymer, quaternary ammonium salt, a hydroxy-terminated polymer, a dispersant, a preservative, and a diluent.

In this case, the hydrophilic polymer may include at least one selected from the group consisting of dextrin, alginate, chitosan, agarose, pullulan, albumin, gelatin, collagen, acrylic acid, acrylamide, allylamine, ethylimine, poly(2-oxazoline), poly(N,N-diethylamide), and n-(2-hydroxypropyl)methacrylamide, and the quaternary ammonium salt may include at least one selected from the group consisting of tetramethylammonium hydroxide, tetramethylammonium chloride, tetrabutylammonium bromide, tetrabutylammonium fluoride, tetrabutylammonium perchlorate, dodecyltrimethylammonium chloride, tetramethylammonium iodide, tridodecylmethylammonium chloride, benzyltrimethylammonium iodide, and tetramethylammonium sulfate.

The hydroxy-terminated polymer may include at least one selected from the group consisting of xanthan gum, guar gum, hyaluronic acid, 1,3-propanediol, polyethylene glycol, polypropylene glycol, hydroxy-terminated polydimethylsiloxane, hydroxy-terminated polybutadiene, hydroxy-terminated poly(2-oxazoline), hydroxy-terminated polymethylmethacrylate, and hydroxy-terminated polyethylene-b-polycaprolactone (OH-terminated polyethylene-b-polycaprolactone).

In more detail, the substance capable of imparting hydroxyl may contain 0.5 to 3 wt % of polyamide epichlorohydrin as a hydrophilic polymer, 1 to 3 wt % of polyDADMAC as quaternary ammonium salt, 1 to 3 wt % of at least one hydroxy-terminated polymer selected from the group consisting of citric acid, butane tetracarboxylic acid (BTCA), and itaconic acid, 0.2 to 2.5 wt % of dipropylene glycol as a dispersant, 0.01 to 1 wt % of a preservative, and 90 to 95 wt % of pure water, based on a total weight of the composition.

According to another embodiment of the present invention, there is provided a thermal transfer method using reactive dye transfer paper, the thermal transfer method including: preparing transfer paper in which a barrier layer and an ink reception layer are sequentially formed on base paper, and preparing the transfer paper having the ink reception layer on which an image is printed by a printing scheme; pretreating an adherend, in which the pretreatment is for separately activating a surface of the adherend by performing a plasma treatment on the adherend; and printing the image by applying heat and pressure while the transfer paper on which the image is printed makes contact with the adherend.

The activating of the surface of the adherend by performing the plasma treatment on the adherend may include performing a treatment for 1 to 8 minutes by using oxygen and helium as activation gases and as sources of plasma.

A composition for manufacturing an ink reception layer in reactive dye transfer paper for thermal transfer printing, in which the reactive dye transfer paper includes a barrier layer and the ink reception layer formed on the barrier layer, may contain 70 to 85 wt % of a binder, 1 to 10 wt % of a filler, 0.5 to 5 wt % of a dispersant, 3 to 7 wt % of a fixing agent, 5 to 10 wt % of a tackifier, 0.5 to 5 wt % of a crosslinking agent, and 0 to 3 wt % of a surfactant, based on a total weight of the composition.

A composition for manufacturing a barrier layer in reactive dye transfer paper for thermal transfer printing, in which the reactive dye transfer paper includes the barrier layer and an ink reception layer formed on the barrier layer, may include 5 to 50 wt % of an octyl phosphate PVA mixture including polyvinyl alcohol, methyl alcohol, and octyl phosphate, for separation after cooling of a design layer, based on a total weight of the barrier layer.

According to the present invention, before the printing, the thermal transfer method using the reactive dye transfer paper may further include supplying moisture to fabric or the transfer paper in order to improve printability of a reactive dye upon thermal transfer of the fabric or a garment.

### Advantageous Effects

According to the present invention, since a digital textile printing method that does not use steaming and a thickener is a dry process that does not use water, waste water may not be generated, so that water pollution and energy waste caused by use of a large amount of water can be avoided.

According to the present invention, a reactive ink reception layer that has been printed can be smoothly released and separated from a printed matter (an adherend: a fiber), so that quality of the printed matter can be improved.

According to the present invention, a process of performing printing by a thermal transfer scheme by using reactive ink transfer paper and pretreating an adherend (a fiber) may be performed in order to prevent conventional generation of an unfixed dye, so that the generation of the unfixed dye caused in the conventional reactive dye printing can be suppressed, and release separation can be smoothly performed, and thus high-performance and commercially-available textile products can be obtained.

### DESCRIPTION OF DRAWINGS

FIG. 1 is a sectional view showing transfer paper in which base paper is coated with a barrier layer and an ink reception layer according to the present invention.

FIG. 2 is a process diagram showing a thermal transfer method according to the present invention.

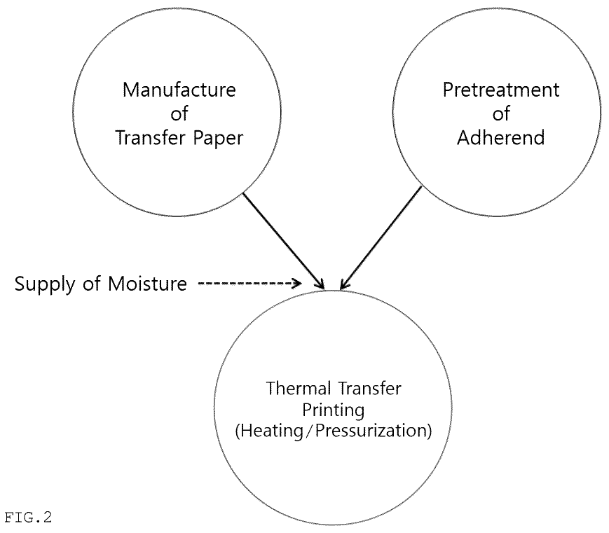

FIG. 3 is a photograph showing a state in which an image is printed on a white T-shirt by the thermal transfer method according to the present invention.

### MODE FOR INVENTION

Hereinafter, an exemplary embodiment in which the objects of the present invention can be specifically implemented will be described with reference to the accompanying drawings. While describing the present embodiment, like names and like reference numerals will be used for like components, and redundant descriptions thereof will be omitted.

The accompanying drawings are partially enlarged and reduced without being drawn according to a scale in order to describe the technical idea of the present invention.

As disclosed in the cited document (Ind. Eng. Chem. Res. 1998, 37, 1781-1785), a hydroxyl group may be supplied to cellulose (a cotton fiber) to change the cellulose into cellulosate, thereby dye-fixing (fixing) a dye.

Reactive transfer paper textile printing may be performed such that the dye is fixed to the cotton fiber (cellulose) by a dye-fixing mechanism as in Reaction Formula 1 (cited document: Ind. Eng. Chem. Res. 1998, 37, 1781-1785) below.

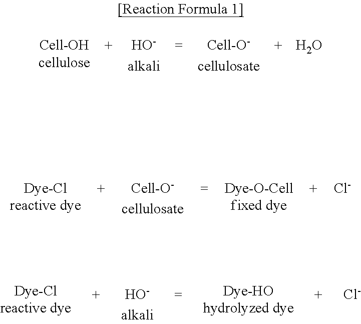 [SMILES: O ; [Cl-] ; [Cl-]]

Dye-fixing (fixing and crosslinking) may require a high temperature (steaming) and pressure.

Conditions of the high temperature and the pressure may be obtained in a process of applying pressure at a high temperature while an adherend and transfer paper to make close contact with each other during a thermal transfer process.

According to the present invention, since the high temperature and the pressure are applied during the thermal transfer process, a highly reactive substance capable of imparting hydroxyl, with which a garment is coated, according to the present invention may react with a hydroxyl group of the garment so as to be cellulosate (first reaction), and the cellulosate may react with a reactive dye so as to be a fixed dye (second reaction), so that generation of an unfixed dye may be suppressed.

Meanwhile, the reason why an unfixed dye is generated by steaming according to the related art is that, since there is no highly reactive substance capable of imparting hydroxyl in the related art, the first reaction may not proceed so that insufficient generation of cellulosate may be caused, and since there is less cellulosate, the second reaction may not smoothly proceed so that a less amount of a fixed dye may be generated, thereby resulting in a large amount of an unfixed dye.

In this case, hydrolysate may react with a reactive element of an ink absorption layer, the remaining hydrolysate may be absorbed and diffused into the ink absorption layer, and a polymer of the ink absorption layer may form a release film, so that release contamination may be prevented.

As described above, an important characteristic of the present invention may be pretreating of the adherend (the fiber, cotton, etc.) in order to prevent the unfixed dye generated in reactive dye printing.

A pretreatment scheme may be divided into a wet scheme (a chemical treatment) and a dry scheme (a physical treatment).

As shown in the dye-fixing (fixing) mechanism of the cited document (citation: Ind. Eng. Chem. Res. 1998, 37, 1781-1785), the wet pretreatment may be performed by dipping or coating a cotton fiber with a highly reactive substance capable of imparting hydroxyl, such as quaternary ammonium salt and diol and triol mixtures, according to a mechanism in which a hydroxyl group of the cotton fiber (cellulose) and alkali ions react with each other. Since the cotton fiber is pretreated as described above, the generation of the unfixed dye, which is a difficult problem in the related art, may be suppressed.

Since the cotton fiber (the adherend) is pretreated, durability of the reactive dye, that is, washing fastness, may also be increased. In other words, since the adherend is dipped or coated with the highly reactive substance capable of imparting hydroxyl,
1) the generation of the unfixed dye, which is a difficult problem in the related art, may be suppressed, and
2) the durability of the reactive dye, that is, the washing fastness, may also be improved because the dipping or coating substance also serves as a fixing agent.

The thermal transfer method according to the present invention includes a process of manufacturing reactive dye transfer paper, a process of pretreating an adherend, and a process of thermally transferring an image to the adherend by performing heating and pressurization while the transfer paper makes contact with the adherend.

The above configuration will be described in detail as follows.

### [Manufacture of Transfer Paper]

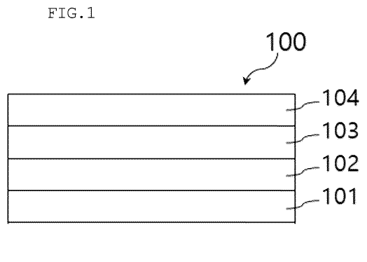

FIG. 1 is a sectional view showing transfer paper 100 according to the present invention, which shows a structure in which base paper 101 is sequentially coated with a barrier layer 102 and an ink reception layer 103.

The transfer paper 100 for thermal transfer printing according to the present invention may be used in a thermal transfer method in which a design layer 104 on which an image is printed by an inkjet printing scheme is formed on the ink reception layer, and heat and pressure are applied so that the image formed on the design layer may be imprinted on an adherend.

The transfer paper may be formed by sequentially stacking a barrier layer and a reactive ink reception layer on paper having an appropriate weight (120 g).

Since a weight of the base paper has a great influence on performance of the transfer paper, the weight of the base paper 101 has to be managed. In addition, base paper of 80 to 150 g/m² may be used, and preferably, base paper having a basis weight of 120 g/m² or more may be required.

Since the barrier layer 102 (a release layer) has to serve to allow the reactive ink reception layer that has been printed to be smoothly separated from a printed matter (a fiber), the barrier layer 102 has to have a hydrophobic surface.

In order to impart such hydrophobicity, a material configuration having a low contact angle has to be provided.

A water-soluble polymer (including an emulsion) may be used as a binder, and a fluorinated oligomer and a siliconized polymer may be used for the hydrophobicity. In particular, in order to facilitate the separation and enable cool peel (a release force in a cooled state), 5 to 50 wt % of an octyl phosphate PVA mixture may be included based on a total weight of the barrier layer. The octyl phosphate PVA mixture may include 100 parts by weight of an aqueous solution including polyvinyl alcohol (PVA) and methyl alcohol in a weight ratio of 5:2 to 5:5 and having a concentration of 5 to 10% (w/w), and 5 to 10 parts by weight of octyl phosphate. Preferably, the octyl phosphate PVA mixture may include 100 parts by weight of an aqueous solution including 5 wt % of polyvinyl alcohol (PVA), 2 wt % of methyl alcohol, and 93 wt % of purified water, and 5 to 10 parts by weight of octyl phosphate.

The barrier layer 102 may include 8 to 20 wt % of a water-soluble polymer (polyvinyl alcohol, polyacrylate, polyurethane, an acrylic emulsion, an ethylene acrylate emulsion, etc.), 10 to 50 wt % of a hydrophobicity impartment agent (fluororesin-based fluorinated alcohol, an aqueous silicone compound, and an octyl phosphate PVA mixture), 3 to 10 wt % of aqueous wax (polyethylene wax and carnauba wax) as a release performance auxiliary agent, 1 to 5 wt % of a film-forming crosslinking agent (blocked isocyanate, melamine, and polyamide), 1 to 5 wt % of a nonionic surfactant, and 20 to 50 wt % of pure water (deionized water) as a diluent.

TABLE 1
Example - Barrier Layer

| Material name | wt % | Note |
|---|---|---|
| Polyacrylate | 15.75 | DA413 (St-Acryl)-Daewon Polymer water- |
| | | soluble polymer, 50 wt % by solid |
| | | content |
| Octyl phosphate | 31.50 | Hydrophobicity impartment agent, cool- |
| PVA mixture | | peel release agent |
| Carnauba wax | 3.10 | Release performance auxiliary agent |
| (aqueous wax) | | |
| Silicone | 15.70 | SI-4000-KCC equivalent, hydrophobicity |
| emulsion | | impartment agent |
| Fluororesin | 1.25 | PTFE Urethane acrylate, release agent |
| hydrophobicity | | |
| impartment agent | | |
| Surfactant | 1.50 | PEG-PPG-PEG copolymer nonionic |
| | | surfactant |
| Crosslinking | 1.00 | Blocked isocyanate |
| agent | | |
| Pure water | 30.20 | Deionized water |
| Total | 100 | |

The ink reception layer 103 may receive a reactive dye ink used in inkjet printing without spreading, and may play the biggest role in reliability of a product after being printed (fastness test: dry fastness and wet fastness). Due to quality requirements, the reactive dye ink reception layer 103 may preferably include a polymer mixture including a binder. At least one substance selected from the group consisting of an acrylic resin, a polyurethane resin, a polyurethane hybrid resin, an ethylene acrylic resin, an acrylic modified resin, sodium alginate, and a nylon resin having a low melting point may be used as the binder.

In more detail, the ink reception layer may include 70 to 85 wt % of a binder, 1 to 10 wt % of a filler, 0.5 to 5 wt % of a dispersant, 3 to 7 wt % of a fixing agent, 5 to 10 wt % of a tackifier, 0.5 to 5 wt % of a crosslinking agent, and 0 to 3 wt % of a surfactant, based on a total weight of an ink reception layer composition. In this case, the diluent may be supplied through the binder.

According to the present invention, a composition for manufacturing an ink reception layer in reactive dye transfer paper for thermal transfer printing may include at least one selected from the group consisting of polyvinyl alcohol, a polyethylene amide copolymer, a polyethylene oxide resin, a styrene butadiene resin, a melamine resin, water-soluble epoxy, and a derivative thereof as the binder.

A general white filler (clay, talc, and silica) may be used as the filler used in the present invention in order to improve ink reception performance.

The crosslinking agent of the present invention may include at least one selected from the group consisting of an epoxy crosslinking agent, isocyanate and blocked isocyanate, polyethyleneimine, and polycarbodiimide in order to improve fastness of a finished product.

TABLE 2
(Example - Ink Reception Layer)

| Material name | wt % | Note |
|---|---|---|
| Sodium alginate | 73.8 | Binder, 2.5 wt % by solid content |
| Urea | 7.38 | Tackifier |
| Sodium bicarbonate | 5.54 | Fixing agent |
| Fumed silica solution | 1.85 | Filler |
| Sodium persulfate | 0.74 | Crosslinking agent |
| Glycerin | 1.48 | Dispersant |
| Sorbitol | 7.36 | Binder-hydrophilic |
| Polyethylene glycol | 1.48 | Dispersant |
| Fluorosurfactant | 0.37 | PTFE urethane acrylate surfactant |
| Total | 100 | |

In this case, pure water may be included in the binder, and about 72 wt % of the pure water may be contained.

### [Pretreatment of Adherend]

While surface treatment processing of an adherend (fabric and a garment) is important even in other printing methods (sublimation printing, screen printing, etc.), the surface treatment processing may be one of greatly important processes in a reactive dye transfer paper transfer method, which constitutes an important characteristic of the present invention.

The pretreatment of the adherend (a fiber, cotton, etc.) may be divided into a wet pretreatment (a chemical treatment) and a dry pretreatment (a physical treatment).

As shown in the dye-fixing (fixing) mechanism of the cited document (citation: Ind. Eng. Chem. Res. 1998, 37, 1781-1785), the wet pretreatment may be performed by dipping or coating a cotton fiber with a highly reactive substance capable of imparting hydroxyl, such as quaternary ammonium salt and diol and triol mixtures, according to a mechanism in which a hydroxyl group of the cotton fiber (cellulose) and alkali ions react with each other. Since the cotton fiber is pretreated as described above, the generation of the unfixed dye, which is a difficult problem in the related art, may be prevented, so that durability of the reactive dye, that is, washing fastness, may be improved.

A wet pretreatment coating agent may contain a hydrophilic polymer, a fixing agent-quaternary ammonium salt (polyamine and polyDADMAC), and a hydroxy-terminated polymer (citric acid and butane tetracarboxylic acid).

In this case, an available hydrophilic polymer may be as follows.
1. A natural hydrophilic polymer:
1) Polysaccharide: dextrin, alginate, chitosan, agarose, and pullulan
2) Protein: albumin, gelatin, and collagen
2. A synthetic hydrophilic polymer:
1) Acrylic acid and acrylamide
2) Amine functional polymer: allylamine, ethylimine, and poly(2-oxazoline), and polyacrylamide: poly(N,N-diethylamide) and n-(2-hydroxypropyl)methacrylamide.

In this case, available quaternary ammonium salt may be as follows.
Tetramethylammonium hydroxide,
tetramethylammonium chloride,
tetrabutylammonium bromide,
tetrabutylammonium fluoride,
tetrabutylammonium perchlorate,
dodecyltrimethylammonium chloride,
tetramethylammonium iodide,
tridodecylmethylammonium chloride,
benzyltrimethylammonium iodide, and
tetramethylammonium sulfate.

In this case, an available hydroxy-terminated polymer may be as follows.
1. Xanthan gum, guar gum, and hyaluronic acid
2. 1,3-propanediol, polyethylene glycol, polypropylene glycol, hydroxy-terminated polydimethylsiloxane, hydroxy-terminated polybutadiene, hydroxy-terminated poly(2-oxazoline), hydroxy-terminated polymethylmethacrylate, and hydroxy-terminated polyethylene-b-polycaprolactone (OH-terminated polyethylene-b-polycaprolactone).

In detail the composition may include 0.5 to 3 wt % of polyamide epichlorohydrin as a hydrophilic polymer, 1 to 3 wt % of polyDADMAC as a reactive fixing agent (quaternary ammonium salt), 1 to 3 wt % of citric acid (BTCA and itaconic acid) as a hydroxy-terminated polymer, 0.2 to 2.5 wt % of dipropylene glycol as a dispersant, 0.01 to 1 wt % of a preservative, and 90 to 95 wt % of pure water as a diluent.

TABLE 3
Example - Pretreatment-Wet

| Material name | wt % | Note |
|---|---|---|
| Polyamide | 1.55 | Hydrophilic polymer |
| epichlorohydrin | | |
| DADMAC | 1.55 | Reactive fixing agent |
| | | (poly (acrylamide-co- |
| | | diallyldimethylammonium chloride) |
| | | solution) |
| Dipropylene glycol | 0.08 | Dispersant |
| Isopropyl alcohol | 0.81 | Dispersant-bubble removal |
| Silicone polyether | 0.01 | Dispersant |
| Isothiazolone | 0.01 | Preservative |
| Itaconic acid | 1.55 | Hydroxyl polymer |
| Pure water | 94.44 | Diluent |
| Total | 100 | |

The dry pretreatment may change a hydrophobic surface into a hydrophilic surface by performing a plasma treatment on an adherend (a fiber). The hydrophilic surface may have a high contact angle so as to have a structure that is easy to adhere. When oxygen and helium gases are used as activation gases to treat a cotton fiber at a room temperature for 1 to 8 minutes, a contact angle may be changed to 130 to 139°, which exhibits hydrophilicity, so that a structure of the cotton fiber may be changed into a structure that is easy to adhere. The hydrophilic surface may promote dye-fixing of a reactive dye, such as the wet pretreatment (cited document: DOI:10.1003/PPAP 201400052). The plasma treatment may be a physical surface treatment scheme that activates a surface of a cotton fiber so as to play an important role in fixing of a reactive dye.

The plasma treatment process may be introduced to implement a continuous printing process.

### [Printing]

Transfer paper on which a design layer (a printing layer) is formed may be prepared by performing printing on transfer paper including a barrier layer and an ink reception layer, with which the paper described above is sequentially coated. In addition, an adherend that is separately subjected to the wet pretreatment or the dry pretreatment as described above may be prepared.

In this case, according to the present invention, moisture may be supplied to the transfer paper and/or the adherend in order to improve printability of a reactive dye upon thermal transfer of fabric and a garment.

The pretreated adherend may make close contact with the transfer paper on which the printing layer (the design layer) is formed, and an image formed on the printing layer may be printed on the adherend by performing heating/pressurization to perform the thermal transfer.

In the heating/pressurization process, a highly reactive substance capable of imparting hydroxyl, with which a garment is coated in the wet pretreatment process, may react with a hydroxyl group of the garment so as to be cellulosate, and the cellulosate may react with a reactive dye so as to be a fixed dye, so that generation of an unfixed dye may be prevented, which is an important process of the present invention.

In the printing, the garment may be subjected to the printing process by a hydraulic (pneumatic) press, and the fabric (textile fabric) may be subjected to the printing process by a roll-to-roll scheme (continuous scheme).

As effects of the present invention, reactive dye printing, which has been recognized as a difficult problem and has not been developed until now, may be improved by developing the transfer paper and the thermal transfer method, which are based on a digital scheme, so that printing that does not use water may be enabled through a consistent process from design to printing. At the same time, printing on various adherends such as various fibers (natural fibers including cotton, such as silk, and artificial fibers such as nylon), polyvinyl chloride artificial leather, and a thermoplastic polyurethane sheet may be performed, quality may exhibit better performance than existing textile printing, use on various materials may be enabled, and environmental friendliness and cost competitiveness may be obtained.

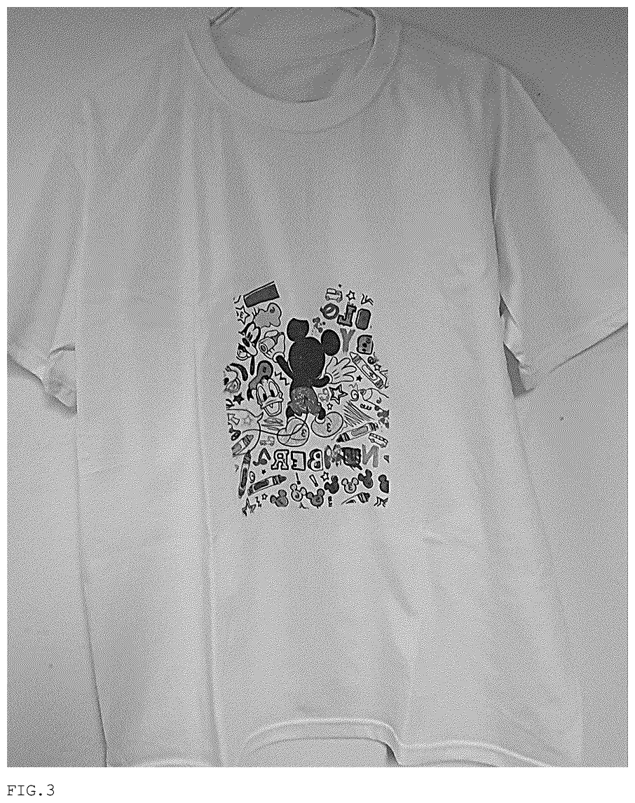

A white cotton T-shirt was prepared as an adherend, and an image was printed on the transfer paper manufactured by the method described above by using the thermal transfer method. The printed T-shirt has been shown in FIG. 3. Washing fastness and light fastness tests were conducted on the printed adherend, and results thereof were shown in Tables 4 and 5.

TABLE 4

| Test item | Test result | Spects |
|---|---|---|
| Discoloration/fading | 4-5 | [Washing fastness] |
| Contamination - Acetate | 4-5 | KSK ISO 105-C06-2014, |
| Contamination - Cotton | 4-5 | A2S Test equipment: |
| Contamination - Nylon | 4-5 | Launder-Ometer (SDL |
| Contamination - Polyester | 4-5 | Atlas, ECE-B standard |
| Contamination - Acryl | 4-5 | detergent) |
| Contamination - Wool | 4-5 | Attached white fabric: |
| | | Multifiber fabric DW type |

TABLE 5

| Test | Test | | |
|---|---|---|---|
| item | result | Specs | |
| Discolo | 3 | [Light fastness] | Test equipment: Weather- |
| ration/ | | KSK ISO 105-B02- | Ometer (Atlas) |
| fading | | 2014, exposure | Judgment: Standard blue dye |
| | | cycle Al, Method | fabric 4, water-cooled xenon |
| | | 3 | arc lamp |

1. A thermal transfer method using reactive ink transfer paper, the thermal transfer method comprising:
preparing transfer paper in which a barrier layer and an ink reception layer are sequentially formed on base paper;
preparing the transfer paper on which an image is printed by printing the image on the ink reception layer by a printing scheme;
pretreating an adherend; and
printing the image by applying heat and pressure while the transfer paper on which the image is printed makes contact with the adherend.

2. The thermal transfer method of claim 1, wherein the pretreating of the adherend includes dipping or coating the adherend with a hydroxyl group impartment composition, or activating a surface of the adherend by performing a plasma treatment on the adherend.

3. The thermal transfer method of claim 2, wherein the hydroxyl group impartment composition includes a hydrophilic polymer, quaternary ammonium salt, a hydroxy-terminated polymer, a dispersant, a preservative, and a diluent,
the hydrophilic polymer includes at least one selected from the group consisting of dextrin, alginate, chitosan, agarose, pullulan, albumin, gelatin, collagen, acrylic acid, acrylamide, allylamine, ethylimine, poly(2-oxazoline), poly(N,N-diethylamide), and n-(2-hydroxypropyl)methacrylamide,
the quaternary ammonium salt includes at least one selected from the group consisting of tetramethylammonium hydroxide, tetramethylammonium chloride, tetrabutylammonium bromide, tetrabutylammonium fluoride, tetrabutylammonium perchlorate, dodecyltrimethylammonium chloride, tetramethylammonium iodide, tridodecylmethylammonium chloride, benzyltrimethylammonium iodide, and tetramethylammonium sulfate, and
the hydroxy-terminated polymer includes at least one selected from the group consisting of xanthan gum, guar gum, hyaluronic acid, 1,3-propanediol, polyethylene glycol, polypropylene glycol, hydroxy-terminated polydimethylsiloxane, hydroxy-terminated polybutadiene, hydroxy-terminated poly(2-oxazoline), hydroxy-terminated polymethylmethacrylate, and hydroxy-terminated polyethylene-b-polycaprolactone (OH-terminated polyethylene-b-polycaprolactone).

4. The thermal transfer method of claim 2, wherein the hydroxyl group impartment composition includes 0.5 to 3 wt % of polyamide epichlorohydrin as a hydrophilic polymer, 1 to 3 wt % of polyDADMAC as quaternary ammonium salt, 1 to 3 wt % of at least one hydroxy-terminated polymer selected from the group consisting of citric acid, butane tetracarboxylic acid (BTCA), and itaconic acid, 0.2 to 2.5 wt % of dipropylene glycol as a dispersant, 0.01 to 1 wt % of a preservative, and 90 to 95 wt % of pure water, based on a total weight of the composition.

5. The thermal transfer method of claim 2, wherein the activating of the surface of the adherend by performing the plasma treatment on the adherend includes performing a treatment for 1 to 8 minutes by using oxygen and helium as activation gases and as sources of plasma.

6. The thermal transfer method claim 1, wherein the ink reception layer is formed of an ink reception layer composition including 70 to 85 wt % of a binder, 1 to 10 wt % of a filler, 0.5 to 5 wt % of a dispersant, 3 to 7 wt % of a fixing agent, 5 to 10 wt % of a tackifier, 0.5 to 5 wt % of a crosslinking agent, and 0 to 3 wt % of a surfactant, based on a total weight of the composition.

7. The thermal transfer method of claim 1, wherein the barrier layer includes 5 to 50 wt % of an octyl phosphate PVA mixture including polyvinyl alcohol, methyl alcohol, and octyl phosphate, based on a total weight of the barrier layer.

8. The thermal transfer method of claim 1, wherein, before the printing, the thermal transfer method further comprises supplying moisture to fabric or the transfer paper in order to improve printability of a reactive dye upon thermal transfer of the fabric or a garment.
